(19) United States
(12) Patent Application Publication
(10) Pub. No.: US 2026/0225747 A1
(43) Pub. Date: Aug. 6, 2026

(54) ROBOT SYSTEM FOR AUTOMATICALLY OPENING AND CLOSING A CONTAINER

(71) Applicant: KUKA Deutschland GmbH, Augsburg (DE)

(72) Inventors: Adil Akbas, Augsburg (DE); Erich Block, Augsburg (DE); Friedrich Sterz, Augsburg (DE); Mathys Pirk, Hanau (DE); Pascal Caprano, Augsburg (DE)

(73) Assignee: KUKA Deutschland GmbH, Augsburg (DE)

(21) Appl. No.: 19/158,307

(22) PCT Filed: Jan. 26, 2024
(86) PCT No.: PCT/EP2024/051878

§ 371 Date: Aug. 20, 2025

(30) Foreign Application Priority Data
Feb. 22, 2023 (DE) 10 2023 104 373.0

(51) Int. Cl. B65B 7/26; B25J 9/16; B25J 13/08

(52) U.S. Cl. CPC B65B 7/26; B25J 9/1679; B25J 13/085

(57) ABSTRACT

A robot system for automatically opening and closing a container. The robot system includes a gripper which is fastened to a tool flange of a robot arm, such that the gripper is automatically movable along a programmed movement path by a robot controller. The programmed movement path is stored in a robot program, the relevant intended joint configuration of the robot arm. The gripper has a first gripping tool for automatically moving a container upper part between its closed position and its open position, and at least one second gripping tool for automatically moving a latching tab of the container between its locking position and its release position.

### CROSS-REFERENCE TO RELATED APPLICATIONS

This application is a national phase application under 35 U.S.C. § 371 of International Patent Application No. PCT/EP2024/051878, filed Jan. 26, 2024 (pending), which claims the benefit of priority to German Patent Application No. DE 10 2023 104 373.0, filed Feb. 22, 2023, the disclosures of which are incorporated by reference herein in their entirety.

### TECHNICAL FIELD

The invention relates to a robot system for automatically opening and closing a container having at least one container lower part, a container upper part which is mounted on the container lower part so as to be movable between a closed position and an open position, and at least one latching tab which is movable between a locking position and a release position and is designed to lock the container upper part, in its closed position, to the container lower part when it is in the locking position, and to release the container upper part for opening when it is in the release position.

### BACKGROUND

WO 2018 192 799 A1 describes a robotic gripper for handling objects, in particular containers, which each comprise at least one holding foot by means of a robot, comprising a gripper main body which has a connecting flange which is designed to fasten the robotic gripper to a tool flange of a robot arm, further comprising a counter-holder which is connected to the gripper main body and has a cutout which is adapted in shape and size to the holding foot of the object in order to be able to receive it in a form-fitting manner, and an actuator which is arranged, preferably movably mounted, on the gripper main body and is designed to press against the holding foot of the object in a clamping position in order to fix it against the counter-holder, and to release the holding foot in a release position such that the counter-holder is movable relative to the holding foot in order to be able to release the holding foot of the object from the robotic gripper.

US 5 123 681 A describes a manually and robot-operated lock for a two-part silicon wafer storage container having a lock attachment portion on one part and a holding portion on the other part for use with the lock, comprising a horizontally extending, rigid upper tab portion having a first end portion with a locking portion suitable for releasable attachment to the holding portion, wherein the horizontally extending, rigid upper tab portion further comprises a second end portion with an elongate connecting pin, a resiliently flexible, curved arc portion having a horizontally extending, rigid lower tab portion, wherein the curved arc portion comprises an upper end portion with pivot pin portions, wherein the pivot pin portions comprises pivot pins adapted for pivotal connection to the closure attachment portion on the storage container, and an elongate, upright, resiliently flexible body portion which is formed in one piece with the horizontally extending upper tab portion and extends between said tab portion and the curved arc portion.

### SUMMARY

The object of the invention is to provide a robot system with which a container designed exclusively for manual handling can nevertheless be handled automatically by means of a robot arm with a gripper appropriately fastened to its tool flange.

The object is achieved by a robot system for automatically opening and closing a container having at least one container lower part, a container upper part which is mounted on the container lower part so as to be movable between a closed position and an open position, and at least one latching tab which is movable between a locking position and a release position and is designed to lock the container upper part, in its closed position, to the container lower part when it is in the locking position, and to release the container upper part for opening when it is in the release position, comprising:
a robot arm having a plurality of links and a plurality of joints, wherein the joints connect the links such that they are movable relative to one another, and having automatically controllable drives, each of which is designed to move one joint of the joints, such that, by automatically controlled movement of the joints by means of the drives, the links of the robot arm can be set to a desired joint configuration,
a robot controller designed to automatically control the drives in order to set the robot arm to an intended joint configuration,
a gripper which is fastened to a tool flange of the robot arm, such that the gripper is automatically movable along a programmed movement path by the robot controller, on which the programmed movement path is stored in a robot program, setting the relevant intended joint configuration of the robot arm, and which gripper has a first gripping tool for automatically moving the container upper part between its closed position and its open position, and
comprising at least one second gripping tool for automatically moving the latching tab between its locking position and its release position.

The robot system is part of an automated workstation and/or the robot system can form the automated workstation. The robot system comprises at least one robot arm, a robot controller for operation of the robot arm which is automatic and program-controlled, or is to be manually controlled in the case of manual operation, and at least one gripper which is in particular fastened to a tool flange of the robot arm. The robot arm can, for example, be designed as an articulated arm robot. The robot arm can accordingly have a kinematic chain of a plurality of links and joints, which in particular comprises links and joints configured alternately in a linear chain. The articulated arm robot can, for example, be designed as a 6-axis robot or a redundant 7-axis robot. Both the robot arm and the associated robot controller can be designed and configured to be able to operate the robot arm in a force/torque-controlled manner, in particular with compliance control. For this purpose, at least one force sensor and/or at least one torque sensor can be assigned to each joint of the robot arm. The force sensors and/or torque sensors of the a plurality of joints of the robot arm provide the robot controller with signals containing information about the forces and/or torques occurring at the relevant joint. Instead of individual force sensors and/or torque sensors in each joint, the robot arm can also have a multi-axis force sensor and/or multi-axis torque sensor mounted on a tool flange of the robot arm.

The container can generally be any container that has at least one container lower part and a container upper part and at least one latching tab.

In particular, the container may be a transport container for a magazine, which is designed to store and transport a group of wafers. The container may therefore be a wafer transport container.

Such containers have a container lower part, a container upper part which is mounted on the container lower part so as to be movable between a closed position and an open position, and at least one latching tab, usually two latching tabs.

Wafer transport containers have been widely used for a long time. Originally, they were intended exclusively for manual transport, i.e. these wafer transport containers are designed in such a way that the latching tabs can be actuated, i.e. locked and released, with the fingers of one hand of a person. The container upper part is also designed such that it can be opened and closed with one person's hands. These wafer transport containers are largely standardized and are used in many existing wafer production facilities.

However, automation technology is increasingly finding its way into wafer production facilities, and the task of automating not only the actual “wafer handling” of individual wafers in clean rooms, but also the transport of wafer transport containers, in particular wafer transport containers that are loaded with wafers to be transported, is becoming more and more common. In common practice, wafers are to be transported from one workstation to another workstation within the wafer production facility, preferably in groups, i.e. a plurality of individual wafers stored together in a magazine. The wafer transport container is intended to protect the wafers from damage and contamination during transport.

Solutions have already been proposed, such as in US 5 123 681 A, in which the wafer transport containers are specially designed for automated handling, particularly for handling by robots. However, such solutions have the disadvantage that they no longer correspond to the previously used standard, but rather are special solutions. Such special solutions are only hesitantly adopted in wafer production because the existing wafer transport containers should continue to be used, especially because the existing workstations are designed for them, and these should not be modified, especially for cost reasons.

The inventive robot system solves the problem by providing a robot system with which the conventional containers designed only for manual handling can also be used at a workstation automated by means of a robot arm.

With the inventive robot system, not only can the at least one latching tab be automatically locked and released, but the container upper part can also be automatically moved from its closed position to its open position and/or from its open position to its closed position by the robot arm.

The container to be handled automatically by the robot system has the at least one latching tab that can be moved between a locking position and a release position. The latching tab is designed to lock the container upper part, in its closed position, to the container lower part when it is in the locking position. This reliably prevents the container upper part from opening accidentally or undesirably.

The latching tab releases the container upper part for opening when it is in the release position. When the latching tab is released, the container upper part can be opened automatically by means of the robot arm. The container upper part can then be closed automatically again at a later time by means of the robot arm. The container may have a single latching tab. However, the container can also, as is conventional, have a plurality of latching tabs, for example two latching tabs. Each latching tab can, for example, be hinged to the container lower part, so that the latching tab can be pivoted back and forth between its locking position and its release position. A latching hook of the relevant latching tab can latch in a form-fitting manner behind a latching projection on the container upper part in the locking position. Each latching tab can have an actuating portion which is designed to be actuated with the fingers of a person's hand.

The robot arm has a plurality of links and a plurality of joints, wherein the joints connect the links such that they are movable relative to one another. Each joint has an automatically controllable drive that is designed to move the associated joint. By automatically controlled movement of the joints by means of the drives, the links of the robot arm can be set to a desired joint configuration. The joint configuration of the robot arm is defined by the set of joint angle position values of all joints of the robot arm. This joint configuration of the robot arm can also be referred to as the pose of the robot arm.

The robot controller is designed to automatically control the drives in order to set the robot arm to an intended joint configuration. For this purpose, a robot program can be stored in the robot controller, which contains positions for the position and orientation of a working point of the robot arm, i.e. a tool center point (TCP) and/or associated travel commands. When the robot program is executed, the robot arm moves accordingly and guides the gripper along a desired path.

The gripper is fastened to a tool flange of the robot arm, such that the gripper is automatically movable along a programmed movement path by the robot controller, on which the programmed movement path is stored in a robot program, setting the relevant intended joint configuration of the robot arm, or a plurality of predetermined joint configurations of the robot arm one after the other, in a continuous movement or point-to-point.

The gripper has at least one first gripping tool which is designed to automatically move the container upper part between its closed position and its open position. The gripper is designed to grip the container upper part without the container upper part having separate, special gripping portions that are specifically designed to be grasped by an automated gripper. The gripper can therefore preferably be designed as a clamping gripper.

The robot system also comprises a second gripping tool for automatically moving the latching tab between its locking position and its release position. The second gripping tool can be provided on the gripper, like the first gripping tool. Alternatively, the second gripping tool can also be installed separately from the gripper within the robot system, i.e. within a workstation which comprises the robot system. The second gripping tool can in particular be arranged in a stationary manner, wherein automatic handling of the at least one latching tab can be carried out by a movement carried out by means of the robot arm, by the gripper of the robot arm gripping the container and bringing it toward the stationary second gripping tool, such that the second gripping tool can interact with the at least one latching tab, and the at least one latching tab is released by an automatic movement of the container in order to release the container upper part. In an analogous manner, locking can also take place in this way.

The feature that the robot controller is designed accordingly means that the robot controller is constructed in this specific way. The feature that the robot controller is configured accordingly means that the robot controller is programmed in this specific way by means of a program or software.

The robot controller can accordingly be designed and configured to detect the forces and/or torques occurring in the respective joints during an automatic movement of the robot arm and the gripper fastened to the tool flange of the robot arm and, on the basis of the detected forces and/or torques, to control the drives of the joints of the robot arm in such a way that, during gripping and moving of the container upper part by means of the first gripping tool from its closed position into its open position, the container lower part remains in its rest position.

What is special about this is that the single robot arm thus emulates a one-arm operation of the container. Therefore, a second arm is missing, so to speak, which could hold the container lower part in place if necessary. The robot controller must therefore control the robot arm with corresponding sensitivity, so that the container upper part can be opened automatically without the container lower part moving along with it. A movement of the container lower part that is to be avoided can be recognized by the fact that more than an expected force and/or more than an expected torque would have to be applied in order to carry out the opening movement for the container upper part than would be necessary for a movement of the container upper part alone. The actual process forces occurring can be detected using sensors of the robot system. The sensors can be formed in particular by the joint sensors, which are already present at the joints of a force/torque-controllable robot arm. The robot arm can be controlled by the robot controller in force/torque-controlled operation, in particular with compliance control.

The robot controller can also be designed and configured to control the drives of the joints of the robot arm on the basis of the detected forces and/or torques to move the container upper part from its closed position to its open position only if, due to the detected forces and/or torques, the process force required to move the container upper part is smaller than a multiple of a weight force of the container upper part, which is determined from the mass of the container upper part.

For example, when opening the container upper part, a process force must be applied which is at least large enough that the weight force of the container upper part can be compensated for and, for example, the friction and other work losses that occur can additionally be overcome. However, these additional forces are less than twice the weight force of the container upper part. For example, process forces may be permissible that are 1.5 times, 1.7 times or 1.9 times the weight force of the container upper part. However, a process force that is greater, i.e. more than twice the weight force of the container upper part, indicates an unacceptable movement of the container upper part. Then, the current automatic movement of the robot arm is stopped and another automatic movement is executed by the robot arm. Due to the specific structure of the container, in particular a wafer transport container, it can be assumed that the container lower part weighs at least as much as the container upper part, or even has a greater weight than the container upper part.

The first gripping tool can be designed as a two-jaw gripper which has two gripper jaws which are automatically movable relative to one another and each gripper jaw of which is designed and configured to grip a lateral side wall of the container upper part in a form-fitting and/or force-fitting manner, in particular by clamping, from two opposite lateral side walls of the container upper part.

The feature that the gripper jaws are designed accordingly means that the gripper jaws are constructed in this specific way. The feature that the gripper jaws are configured accordingly means that the gripper jaws are controlled accordingly by the robot controller, and the robot controller is programmed in this specific way by means of a program or software.

The front side of the container, in particular of a wafer transport container, is formed by the side that is open for removal or insertion when the container upper part is open, but is not the upper side. The container upper part can in this respect have a flap portion extending downward, which closes off a front access opening of the container lower part when the container upper part is in the closed position. Markings, notes, stickers or similar items containing information, for example about the type of contents being transported, are usually attached to this front flap portion of the container upper part. This makes it difficult for the first gripping tool to use the front flap portion of the container upper part. Therefore, in the special embodiment, the two-jaw gripper engages on opposite lateral sides of the container, i.e. the left-hand side and the right-hand side with respect to the front of the container, and not in the region of the front flap portion.

A two-jaw gripper is understood to be a clamping gripper or a suction gripper, which has at least one gripper finger on opposite sides relative to the container. However, not only can a single gripper finger be provided on each side, but rather two or more individual gripper fingers, or gripper fingers in groups, can also be provided on each side.

The opposing gripper jaws or gripper fingers are mounted so as to be movable relative to one another, such that they can selectively be automatically moved toward each other and away from each other. For this purpose, the first gripping tool can comprise a drive, such as an electric motor or a pneumatic cylinder, which can be automatically controlled, for example by the robot controller.

Each gripper jaw can have a clamping piece which has a contact surface for contact with the relevant lateral side wall of the container upper part, wherein the clamping piece is rotatably mounted by means of a ball joint on a gripper jaw main body of the gripper jaw, in particular is mounted so as to be rotatable about a rotation axis running through the two clamping points of the two gripper jaws on the opposite lateral side walls of the container upper part.

Each gripper jaw forms a gripper finger, at the tip of which the clamping piece is arranged. The clamping piece forms a connecting body which is positioned between the actual gripper jaw or the actual gripper finger and the associated side wall of the container when the two-jaw gripper grips the container. The clamping piece is arranged on the relevant gripper jaw, in particular mounted or fastened thereto. The clamping piece has a contact surface facing the container. The contact surface can have a surface structure, in particular a surface roughness, which improves contact with the container, and in particular has a high coefficient of friction when the clamping piece is in contact with the associated side wall of the container.

Because the clamping piece is rotatably mounted on the gripper jaw main body of the gripper jaw by means of the ball joint, the robot arm and thus the gripper can pivot the container upper part by a required pivot angle without the gripper or the robot arm having to fully execute this pivot angle therewith. Due to the opposite ball joints, the gripper can be rotated relative to the clamped container, specifically about a rotation axis that runs in parallel with the pivot axis around which the container upper part pivots. In this embodiment, the container upper part is mounted on the container lower part so as to be pivotable about the pivot axis, for example by means of at least one hinge. As a result, the container upper part can be pivoted by the pivot angle together with the gripping gripper, wherein the gripper only needs to be rotated by a smaller angle of rotation or even not at all. This allows the gripper to be guided by the robot arm along a movement path that can be designed to be much simpler than a movement path in which the gripper must be rotated by the same pivot angle as the container upper part.

The robot controller can accordingly be designed and configured to hold the gripper and/or the tool flange of the robot arm at least substantially in its initial orientation, or to merely execute a pivoting movement with a smaller pivot angle than the pivot angle for completely opening the container upper part, during a movement of the gripper carried out to open the container upper part, while the gripper clamps the container upper part by means of the gripper jaws of the first gripping tool.

The second gripping tool, for automatically moving the latching tab between its locking position and its release position, can be fastened to the gripper, and the automatic movement of the latching tab between its locking position and its release position can be carried out by the robot controller automatically controlling the drives of the joints of the robot arm, such that the second gripping tool is moved accordingly for automatically actuating the latching tab.

By fastening the second gripping tool to the gripper, the release or locking of the at least one latching tab can be carried out by an automatic movement of the robot arm controlled by the robot controller, without the container having to be moved. There is also no need to change the tool, as both the first gripping tool and the second gripping tool are together fastened to the tool flange of the robot arm. In this embodiment, however, the gripper must be repositioned after the release of the latching tabs by means of the second gripping tool, so that the first gripping tool can engage the container upper part in order to open the container upper part.

The second gripping tool, for automatically moving the latching tab between its locking position and its release position, can be fastened in a stationary manner to a fixed holder of a workstation of the robot system, and the automatic movement of the latching tab between its locking position and its release position can be carried out by the robot controller automatically controlling the drives of the joints of the robot arm, such that the first gripping tool moves the entire container, specifically in such a way that the closed latching tab is brought to the second gripping tool, which is fastened in a stationary manner, and is brought into engagement therewith, such that the at least one latching tab is opened by means of an automatically executed further movement of the container by controlled movement of the joints of the robot arm.

In this embodiment, the gripper does not have to be repositioned after the release of the latching tabs by means of the second gripping tool; rather, the first gripping tool, which already holds the container during the release of the latching tabs, can move the container upper part without changing grip, in order to open the container upper part in one continuous movement.

The robot controller can be designed and configured to automatically guide the gripper, for automatically moving the latching tab between its locking position and its release position, in such a way that only one latching tab is opened or closed at a time.

If only one latching tab is actuated at a time, the risk of unintentional tipping or displacement of the container lower part is reduced, as only lower process forces are required than in the case of process alternatives in which two or more latching tabs are actuated simultaneously.

The container lower part can be held in a form-fitting manner, at least against slipping in its standing plane, in a stationary receptacle of the robot system, at least during the automatic opening or closing of the container upper part.

The receptacle can, for example, be formed by a frame-like, circumferential heel or a U-shaped three-sided heel arranged on a work surface. The heel or three-sided heel limits the container lower part in a form-fitting manner, so that it cannot slip.

Specific embodiments of the invention are explained in more detail in the following description with reference to the accompanying drawings. Specific features of these exemplary embodiments, possibly considered individually or in further combinations, can represent general features of the invention, regardless of the specific context in which they are mentioned.

### BRIEF DESCRIPTION OF THE DRAWINGS

The accompanying drawings, which are incorporated in and constitute a part of this specification, illustrate exemplary embodiments of the invention and, together with a general description of the invention given above, and the detailed description given below, serve to explain the principles of the invention.

FIG. 1 depicts an exemplary robot system with a robot arm, a robot controller and a gripper in accordance with the principles of the present disclosure,

FIG. 2 is a perspective view of an exemplary container designed as a wafer transport container in its open position,

FIG. 3 is a perspective view of the exemplary container designed as a wafer transport container according to FIG. 2 in its closed position,

FIG. 4 is a perspective view of the exemplary first gripping tool of a gripper of the robot arm,

FIG. 5 is a perspective view of an exemplary second gripping tool in an attachment variant on the gripper of the robot arm, and

FIG. 6 is a perspective view of an exemplary second gripping tool in an arrangement which is separate from the gripper of the robot arm and is stationary.

### DETAILED DESCRIPTION

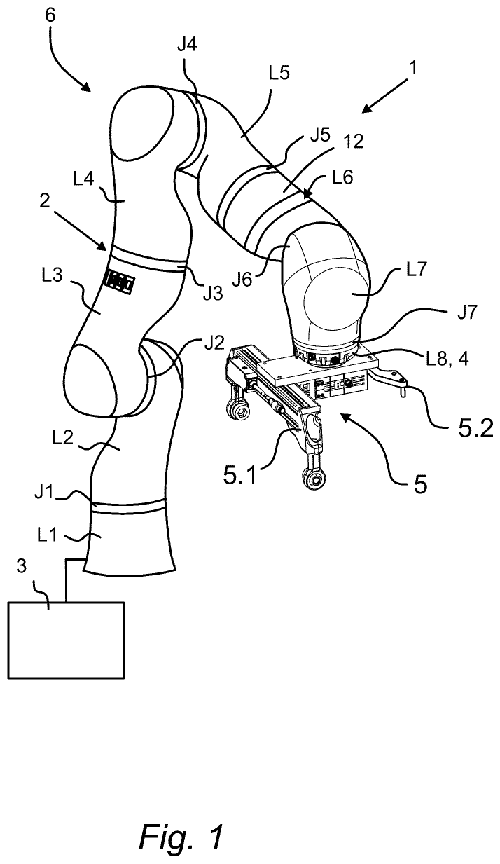

FIG. 1 shows a robot 1 in an exemplary embodiment as a so-called lightweight robot, which has a robot arm 2 and a robot controller 3. In the present embodiment, the robot arm 2 comprises a plurality of links L1-L8 which are arranged one after the other and are connected so as to be rotatable relative to one another by means of joints J1-J7. In the embodiment shown in FIG. 1, the link L8 is designed as a tool flange 4 for fastening a gripper 5. The gripper 5 has at least one first gripping tool 5.1. The gripper 5 can optionally also have a second gripping tool 5.2, as shown.

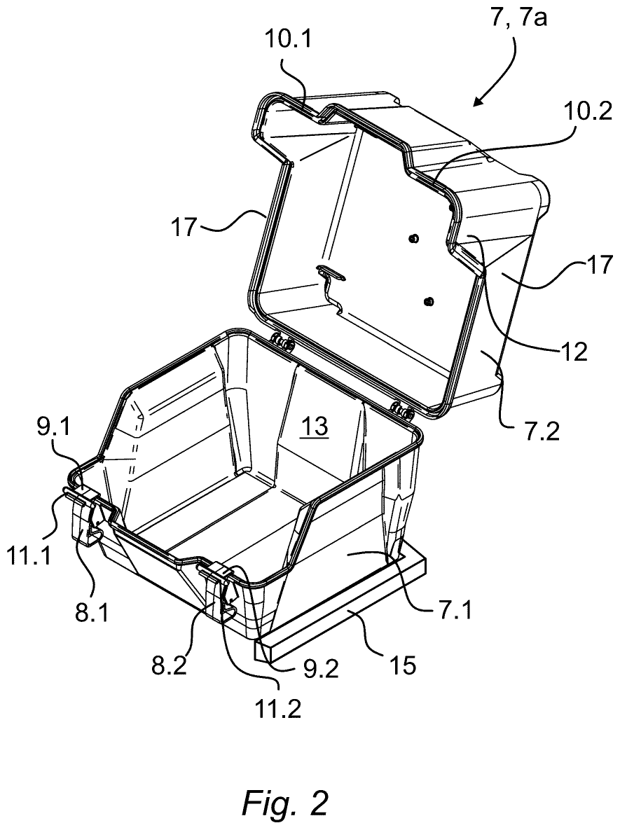

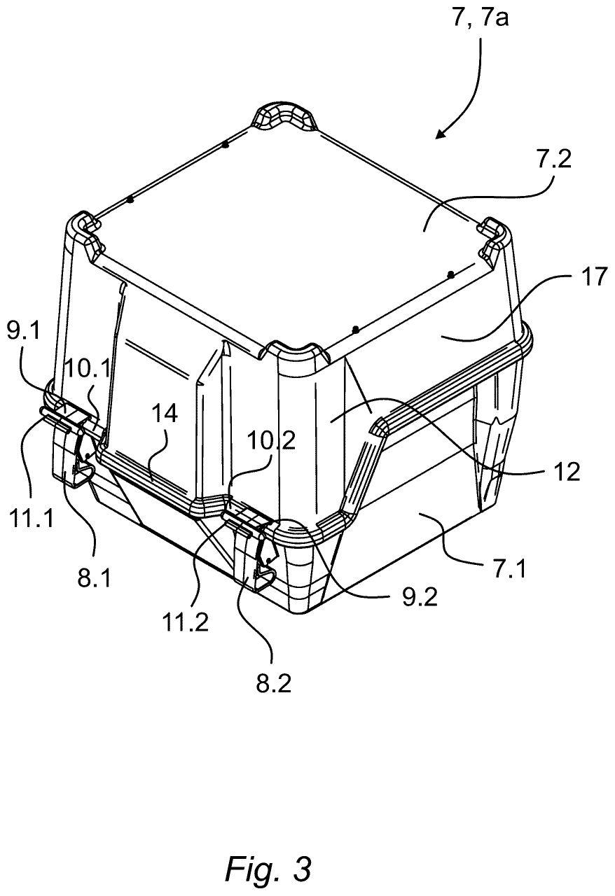

The robot system 6 shown by way of example is used for the automatic opening and closing of a container 7 (FIG. 2 and FIG. 3) having at least one container lower part 7.1, a container upper part 7.2 which is mounted on the container lower part 7.1 so as to be movable between a closed position (FIG. 3) and an open position (FIG. 2), and at least one—in the case of the embodiment shown, two—latching tabs 8.1 and 8.2 which can be moved between a locking position (FIG. 3) and a release position (FIG. 2) and are designed to lock the container upper part 7.2, in its closed position, to the container lower part 7.1 when it is in the locking position, and to release the container upper part 7.2 for opening when it is in the release position.

The robot system 6 has a robot arm 2 having a plurality of links L1-L8 and a plurality of joints J1-J7, wherein the joints J1-J7 connect the links L1-L8 such that they are movable relative to one another, and having automatically controllable drives (inside the robot arm 2, not visible), each of which is designed to move one joint J1-J7 of the joints J1-J7, such that, by automatically controlled movement of the joints J1-J7 by means of the drives, the links L1-L8 of the robot arm 2 can be set to a desired joint configuration.

The robot system 6 additionally has a robot controller 3 which is designed to automatically control the drives in order to set the robot arm 2 to an intended joint configuration.

The robot system 6 also has a gripper 5 which is fastened to a tool flange 4 of the robot arm 2, such that the gripper 5 is automatically movable along a programmed movement path by the robot controller 3, on which the programmed movement path is stored in a robot program, setting the relevant intended joint configuration of the robot arm 2.

The gripper 5 has at least one first gripping tool 5.1 for automatically moving the container upper part 7.2 between its closed position (FIG. 3) and its open position (FIG. 2).

The robot system 6 also has at least one second gripping tool 5.2 for automatically moving the latching tabs 8.1, 8.2 between their locking position and their release position.

As shown in FIG. 2, the latching tabs 8.1, 8.2 release the container upper part 7.2 for opening when it is in the release position. When the latching tabs 8.1, 8.2 are released, the container upper part 7.2 can be opened automatically by means of the robot arm 2. The container upper part 7.2 can then be closed automatically again at a later time using the robot arm 2. The container 7 can have a single latching tab 8.1. However, the container 7 can also, as shown in FIG. 2 and FIG. 3, have a plurality of latching tabs 8.1, 8.2, for example two latching tabs 8.1, 8.2 as shown. Each latching tab 8.1, 8.2 can, for example, be hinged to the container lower part 7.1 so that the latching tabs 8.1, 8.2 can each be pivoted back and forth between their locking positions and their release positions. Each latching hook 9.1, 9.2 of the respective latching tabs 8.1, 8.2 can latch in a form-fitting manner behind a latching projection 10.1, 10.2 on the container upper part 7.2 in the locking position. Each latching tab 8.1, 8.2 can have an actuating portion 11.1, 11.2 which is designed to be actuated with the fingers of a person's hand.

The front side of the container 7, in particular of a wafer transport container 7a, is formed by the side that is open for removal or insertion when the container upper part 7.2 is opened, but is not the upper side. The container upper part 7.2 can in this respect have a flap portion 12 extending downward which closes off a front access opening 13 of the container lower part 7.1 when the container upper part 7.2 is in the closed position. Markings, notes, stickers or similar items containing information, for example about the type of contents being transported, are usually attached to this front flap portion 12 of the container upper part 7.2, for example in a pocket 14 designed for this purpose. This makes it difficult for the first gripping tool 5.1 to use the front flap portion 12 of the container upper part 7.2. Therefore, in the special embodiment shown, it is provided that the gripper 5, in the form of a two-jaw gripper, engages on opposite lateral sides of the container 7, i.e. the left-hand side and the right-hand side with respect to the front of the container 7, and not in the region of the front flap portion 12.

The robot controller 3 is designed and configured to detect the forces and/or torques occurring the respective joints J1-J7 during an automatic movement of the robot arm 2 and of the gripper 5 fastened to the tool flange 4 of the robot arm 2 and, on the basis of the detected forces and/or torques, to control the drives of the joints J1-J7 of the robot arm 2 in such a way that, during gripping and moving of the container upper part 7.2 by means of the first gripping tool 5.1 from its closed position (FIG. 3) into its open position (FIG. 2), the container lower part 7.1 remains in its rest position.

The container lower part 7.1 can be held in a form-fitting manner, at least against slipping in its standing plane, in a stationary receptacle 15 of the robot system 6, at least during the automatic opening or closing of the container upper part 7.2.

In the present embodiment, the robot controller 3 is designed and configured to control the drives of the joints J1-J7 of the robot arm 2 on the basis of the detected forces and/or torques to move the container upper part 7.2 from its closed position to its open position only if, due to the detected forces and/or torques, the process force required to move the container upper part 7.2 is smaller than a multiple of a weight force of the container upper part 7.2, which is determined from the mass of the container upper part 7.2.

For example, for opening the container upper part 7.2, a process force must be applied which is at least large enough that the weight force of the container upper part 7.2 can be compensated for and, for example, the friction and other work losses that occur can additionally be overcome. However, these additional forces are less than twice the weight force of the container upper part 7.2. For example, process forces may be permissible that are 1.5 times, 1.7 times or 1.9 times the weight force of the container upper part 7.2. However, a process force that is greater, i.e. more than twice the weight force of the container upper part 7.2, indicates an unacceptable movement of the container upper part 7.2. Then, the current automatic movement of robot arm 2 is stopped and another automatic movement is executed by the robot arm 2. Due to the specific structure of the container 7, in particular a wafer transport container 7a, it can be assumed that the container lower part 7.1 weighs at least as much as the container upper part 7.2, or even has a greater weight than the container upper part 7.2.

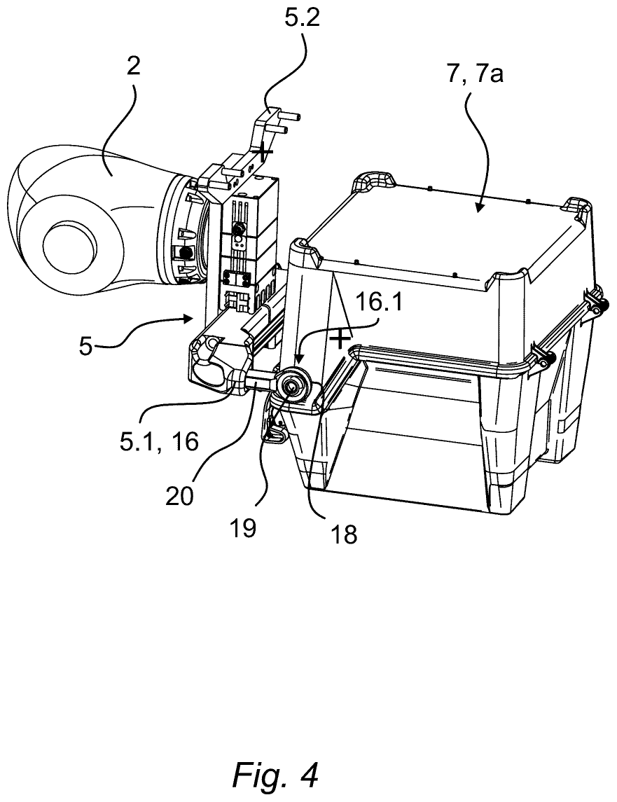

As shown in more detail in FIG. 4, the first gripping tool 5.1 can be designed as a two-jaw gripper 16 which has two gripper jaws 16.1 and 16.2 which are automatically movable relative to one another and each gripper jaw 16.1, 16.2 of which is designed and configured to grip a lateral side wall 17 (FIG. 2) of the container upper part 7.2 in a form-fitting and/or force-fitting manner, in particular by clamping, from two opposite lateral side walls 17 of the container upper part 7.2.

Each gripper jaw 16.1, 16.2 can have a clamping piece 18 which has a contact surface for contact with the corresponding lateral side wall 17 of the container upper part 7.2, wherein the clamping piece 18 is rotatably mounted by means of a ball joint 19 on a gripper jaw main body 20 of the gripper jaw 16.1, 16.2, in particular is mounted so as to be rotatable about a rotation axis running through the two clamping points of the two gripper jaws 16.1, 16.2 on the opposite lateral side walls 17 of the container upper part 7.2.

The robot controller can be designed and configured to hold the gripper 5 and/or the tool flange 4 of the robot arm 2 at least substantially in its initial orientation, or to merely execute a pivoting movement with a smaller pivot angle than the pivot angle for completely opening the container upper part 7.2, during a movement of the gripper 5 carried out to open the container upper part 7.2, while the gripper clamps the container upper part 7.2 by means of the gripper jaws 16.1, 16.2 of the first gripping tool 5.1.

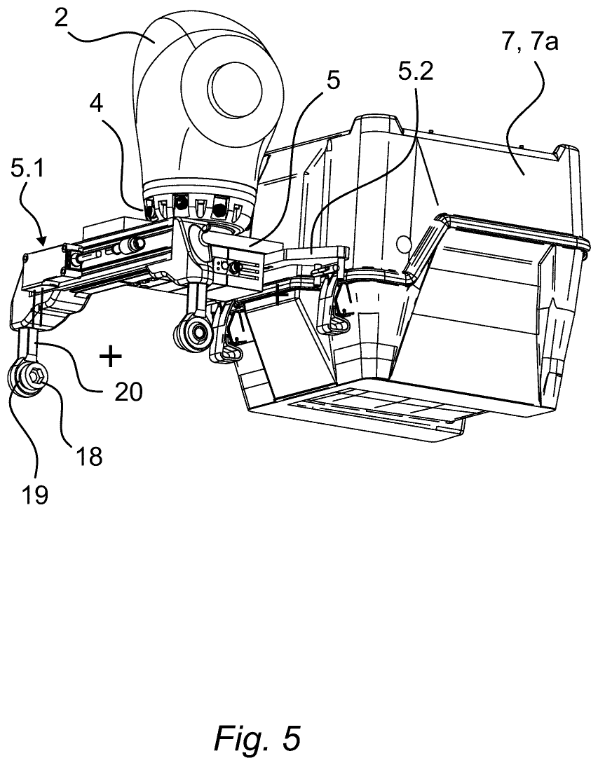

The second gripping tool 5.2 can be fastened to the gripper 5 for automatically moving the latching tabs 8.1, 8.2 between their locking positions and their release positions, as shown in FIG. 5. The automatic movement of the latching tabs 8.1, 8.2 between their locking positions and their release positions is carried out individually, by the robot controller 3 automatically controlling the drives of the joints J1-J7 of the robot arm 2, such that the second gripping tool 5.2 is moved accordingly to automatically actuate the latching tabs 8.1, 8.2, either individually or both simultaneously.

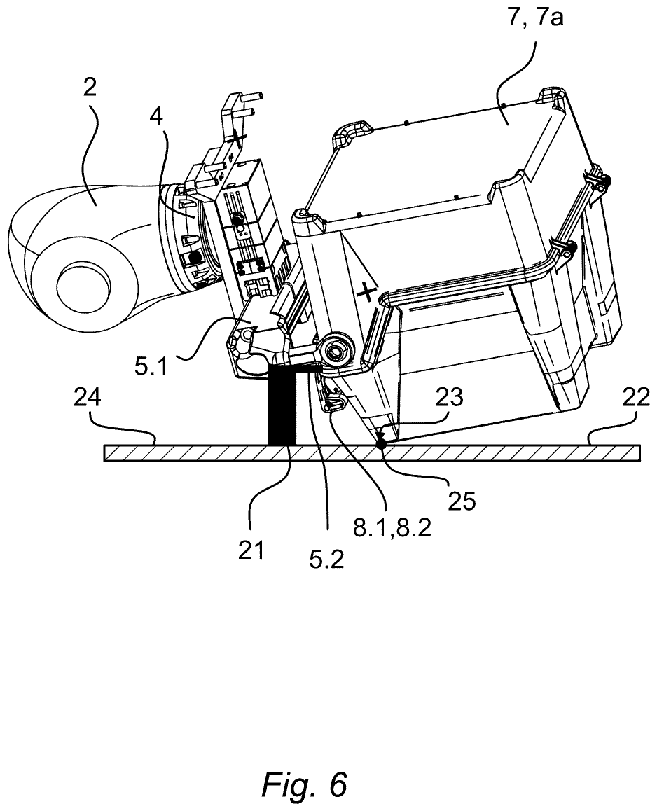

FIG. 6 shows how the second gripping tool 5.2 for automatically moving the latching tabs 8.1, 8.2 between their locking positions and their release positions can be fastened to a fixed holder 21 of a workstation 22 of the robot system 6 in a stationary manner, and the automatic movement of the latching tabs 8.1, 8.2 between their locking positions and their release positions is carried out by the robot controller 3 automatically controlling the drives of the joints J1-J7 of the robot arm 2, such that the first gripping tool 5.1 moves the entire container 7, specifically in such a way that the closed latching tabs 8.1, 8.2 are brought to the second gripping tool 5.2, which is fastened in a stationary manner, and are brought into engagement therewith, such that the latching tabs 8.1, 8.2 are opened by means of an automatically executed further movement of the container 7 by controlled movement of the joints J1-J7 of the robot arm 2.

In this case, during the automatic pivoting of the container 7 by means of the robot arm 2, a lower edge 23 of the container 7 can roll on a work surface 24 around a pivot point 25 in order to release the latching tab 8.1, 8.2 located on the second gripping tool 5.2 on the fixed holder 21. In continuation of such a rotational movement of the container 7, the container lower part 7.1 comes to rest flat on the work surface 24, and due to the released latching tabs 8.1, 8.2, the container upper part 7.1 can be swung open by itself.

However, the robot controller 3 can also be designed and configured to automatically guide the gripper 5, for automatically moving the latching tabs 8.1, 8.2 between their locking positions and their release positions, in such a way that only one latching tab 8.1, 8.2 is opened or closed at a time.

While the present invention has been illustrated by a description of various embodiments, and while these embodiments have been described in considerable detail, it is not intended to restrict or in any way limit the scope of the appended claims to such de-tail. The various features shown and described herein may be used alone or in any combination. Additional advantages and modifications will readily appear to those skilled in the art. The invention in its broader aspects is therefore not limited to the specific details, representative apparatus and method, and illustrative example shown and described. Accordingly, departures may be made from such details without departing from the spirit and scope of the general inventive concept.

What is claimed is:

1. Robot system for automatically opening and closing a container (7) having at least one container lower part (7.1), a container upper part (7.2) which is mounted on the container lower part (7.2) so as to be movable between a closed position and an open position, and at least one latching tab (8.1, 8.2) which is movable between a locking position and a release position and is designed to lock the container upper part (7.2), in its closed position, to the container lower part (7.1) when it is in the locking position, and to release the container upper part (7.2) for opening when it is in the release position, comprising:
a robot arm (2) having a plurality of links (L1-L8) and a plurality of joints (J1-J7), wherein the joints (J1-J7) connect the links (L1-L8) such that they are movable relative to one another, and having automatically controllable drives, each of which is designed to move one joint (J1-J7) of the joints (J1-J7), such that, by automatically controlled movement of the joints (J1-J7) by means of the drives, the links (L1-L8) of the robot arm (2) can be set to a desired joint configuration,
a robot controller (3) which is designed to automatically control the drives in order to set the robot arm (2) to an intended joint configuration,
a gripper (5) which is fastened to a tool flange (4) of the robot arm (2), such that the gripper (5) is automatically movable along a programmed movement path by the robot controller (3), on which the programmed movement path is stored in a robot program, setting the relevant intended joint configuration of the robot arm (2), and which gripper has a first gripping tool (5.1) for automatically moving the container upper part (7.2) between its closed position and its open position, and
comprising at least one second gripping tool (5.2) for automatically moving the latching tab (8.1, 8.2) between its locking position and its release position.

2. Robot system according to claim 1, characterized in that the robot controller (3) is designed and configured to detect the forces and/or torques occurring in the respective joints (J1-J7) during an automatic movement of the robot arm (2) and of the gripper (5) fastened to the tool flange (4) of the robot arm (2) and, on the basis of the detected forces and/or torques, to control the drives of the joints (J1-J7) of the robot arm (2) in such a way that, during gripping and moving of the container upper part (7.2) by means of the first gripping tool (5.1) from its closed position into its open position, the container lower part (7.1) remains in its rest position.

3. Robot system according to claim 2, characterized in that the robot controller (3) is designed and configured to control the drives of the joints (J1-J7) of the robot arm (2) on the basis of the detected forces and/or torques to move the container upper part (7.2) from its closed position to its open position only if, due to the detected forces and/or torques, the process force required to move the container upper part (7.2) is smaller than a multiple of a weight force of the container upper part (7.2), which is determined from the mass of the container upper part (7.2).

4. Robot system according to claim 1, characterized in that the first gripping tool (5.1) is designed as a two-jaw gripper (16) which has two gripper jaws (16.1, 16.2) which are automatically movable relative to one another and each gripper jaw (16.1, 16.2) of which is designed and configured to grip a lateral side wall (17) of the container upper part (7.2) in a form-fitting and/or force-fitting manner, in particular by clamping, from two opposite lateral side walls (17) of the container upper part (7.2).

5. Robot system according to claim 4, characterized in that each gripper jaw (16.1, 16.2) has a clamping piece (18) which has a contact surface for contact with the relevant lateral side wall (17) of the container upper part (7.2), wherein the clamping piece (18) is rotatably mounted by means of a ball joint (19) on a gripper jaw main body (20) of the gripper jaw (16.1, 16.2), in particular is mounted so as to be rotatable about a rotation axis running through the two clamping points of the two gripper jaws (16.1, 16.2) on the opposite lateral side walls (17) of the container upper part (7.2).

6. Robot system according to claim 5, characterized in that the robot controller (3) is designed and configured to hold the gripper (5) and/or the tool flange (4) of the robot arm (2) at least substantially in its initial orientation, or to merely execute a pivoting movement with a smaller pivot angle than the pivot angle for completely opening the container upper part (7.2), during a movement of the gripper (5) carried out to open the container upper part (7.2), while the gripper clamps the container upper part (7.2) by means of the gripper jaws (16.1, 16.2) of the first gripping tool (5.1).

7. Robot system according to claim 1, characterized in that the second gripping tool (5.2) for automatically moving the latching tab (8.1, 8.2) between its locking position and its release position is fastened to the gripper (5), and the automatic movement of the latching tab (8.1, 8.2) between its locking position and its release position is carried out by the robot controller (3) automatically controlling the drives of the joints (J1-J7) of the robot arm (2), such that the second gripping tool (5.2) is moved accordingly for automatically actuating the latching tab (8.1, 8.2).

8. Robot system according to claim 1, characterized in that the second gripping tool (5.2) for automatically moving the latching tab (8.1, 8.2) between its locking position and its release position is fastened to a fixed holder (21) of a workstation (22) of the robot system (6) in a stationary manner, and the automatic movement of the latching tab (8.1, 8.2) between its locking position and its release position is carried out by the robot controller (3) automatically controlling the drives of the joints (J1-J7) of the robot arm (2), such that the first gripping tool (5.1) moves the entire container (7), specifically in such a way that the closed latching tab (8.1, 8.2) is brought to the second gripping tool (5.2), which is fastened in a stationary manner, and is brought into engagement therewith, such that the at least one latching tab (8.1, 8.2) is opened by means of an automatically executed further movement of the container (7) by controlled movement of the joints (J1-J7) of the robot arm (2).

9. Robot system according to claim 1, characterized in that the robot controller (3) is designed and configured to automatically guide the gripper (5), for automatically moving the latching tab (8.1, 8.2) between its locking position and its release position, in such a way that only a single latching tab (8.1, 8.2) is opened or closed at a time.

10. Robot system according to claim 1, characterized in that the container lower part (7.1) is held in a form-fitting manner, at least against slipping in its standing plane, in a stationary receptacle (15) of the robot system (6), at least during the automatic opening or closing of the container upper part (7.2).
